(19) United States
(12) Patent Application Publication
(10) Pub. No.: US 2023/0234862 A1
(43) Pub. Date: Jul. 27, 2023

(54) AN ANNULAR BUBBLING ELECTRIC DISCHARGE REACTOR FOR TREATMENT OF WATER

(71) Applicants: Selma Mededovic Thagard, Potsdam, NY (US); Mikhail Vasilev, Potsdam, NY (US)

(72) Inventors: Selma Mededovic Thagard, Potsdam, NY (US); Mikhail Vasilev, Potsdam, NY (US)

(73) Assignee: CLARKSON UNIVERSITY, POTSDAM, NY (US)

(21) Appl. No.: 18/100,490

(22) Filed: Jan. 23, 2023

Related U.S. Application Data
(60) Provisional application No. 63/302,001, filed on Jan. 21, 2022.

(51) Int. Cl. C02F 1/46; C02F 1/30

(52) U.S. Cl. CPC C02F 1/4608; C02F 1/30

(57) ABSTRACT

An annular bubbling electric discharge reactor for treating water includes a non-conductive pipe having a top and a bottom with a gas sparger installed within the non-conductive pipe and positioned adjacent the bottom and adapted to generate bubbles or foam and control the bubble size formation. A high voltage electrode is fixed concentrically within the non-conductive pipe and a ground electrode is fixed at an intermediate position within the non-conductive pipe and in circumferential relation to the high voltage electrode with an annular space defined between the ground electrode and high voltage electrode. A liquid inlet and a liquid outlet are provided to allow polluted liquid/water into the reactor and discharge treated liquid/water therefrom. A circuit and power supply are provided for generating an electrical discharge between the high voltage electrode and ground electrode, thereby creating a plasma generation region where the liquid is treated.

### CROSS-REFERENCE TO RELATED APPLICATION

This application claims priority to U.S. Provisional Patent Application Ser. No. 63/302,001, filed on Jan. 21, 2022, and entitled “AN ANNULAR BUBBLING ELECTRIC DISCHARGE REACTOR FOR TREATMENT OF WATER,” the entire disclosure of which is incorporated herein by reference.

### GOVERNMENT FUNDING

This invention was made with Government support under Grant DE-SC0020232 awarded by the Department of Energy. The United States Government has certain rights in the invention.

### FIELD OF THE INVENTION

The present disclosure is directed generally to methods and systems for treating liquids and foams. More specifically, treatment of liquids and foams using a plasma-based process.

### BACKGROUND

Pollutant removal from contaminated waters of various origins is the basis of a number of water treatment processes. Conventional methods of pollutant abatement include physical separation, e.g., membrane separation techniques, physicochemical removal methods such as coagulation followed by sedimentation or adsorption on composite supports, and chemical-based methods such as persulfate oxidation, photocatalytic oxidation and others. However, these processes possess some inherent disadvantages. The processes that are based on physical or physicochemical contaminant removal often do not change the original chemical structure of the contaminant molecule, and, as a result, the output of such processes is a concentrated form of the original mixture of contaminants that requires further treatment. On the other hand, chemical-based methods do degrade the original contaminant molecule; however, such methods usually require addition of a reactive chemical agent (e.g., hydrogen peroxide), addition of catalyst, or additional energy input in a form of heat or light.

Gas phase plasmas in contact with liquid offer a promising alternative to the conventional treatment techniques as such plasma processes generate a mixture of strong oxidative and reductive species capable of chemically degrading target pollutants, while not requiring any additives. Yet, the heterogeneous nature of plasma-liquid processes reveals the main disadvantage of the plasma-based treatment. Gas phase electric discharges generate an abundance of highly reactive species. However, pollutant degradation occurs prevalently at the interface between the plasma and the liquid phases. Thus, the overall performance of such processes is limited by the transport of the pollutant to the plasma-liquid interface, i.e., the rate of interface regeneration.

Indeed, the existing energy efficient plasma reactors for water treatment either maximize plasma-liquid contact area extensively by scaling electrodes' physical dimensions, or intensively by generating an atomized liquid (discrete phase) in contact with partially ionized gas, plasma, as a continuous phase. The main disadvantage of these two approaches is poor process scalability due to high capital costs in the former case and low liquid throughput in the latter case.

Accordingly, there is a need in the art for an electric discharge reactor for treatment of water that requires relatively lower capital costs as compared to presently available reactors and process a suitable throughput of liquid.

### SUMMARY

The present disclosure is directed to an annular bubbling electric discharge reactor for treatment of water.

According to an aspect is an annular bubbling electric discharge reactor for treating liquid comprising a pipe having a top and a bottom; a gas sparger installed within the pipe; a high voltage electrode fixed concentrically within the pipe; a ground electrode fixed at an intermediate position within the pipe and in circumferential relation to the high voltage electrode with an annular space defined between the ground electrode and high voltage electrode; a liquid inlet and a liquid outlet; and a circuit and power supply for generating an electrical discharge between the high voltage electrode and ground electrode, thereby creating a plasma generation region.

According to an embodiment. the liquid outlet is positioned adjacent the top of the reactor and the liquid inlet is positioned adjacent the bottom of the reactor.

According to an embodiment, the liquid outlet is positioned adjacent the bottom of the reactor and the liquid inlet is positioned adjacent the top of the reactor.

According to an embodiment, the liquid inlet introduces liquid between the ground electrode and the high voltage electrode.

According to an embodiment, the gas sparger is positioned adjacent the bottom, and adapted to generate bubbles or foam and control the bubble size formation.

According to an embodiment, the pipe is composed of a composite material having both conductive and non-conductive portions.

According to an aspect, a method is provided for treating liquid in a the bubbling discharge reactor having a pipe, a high voltage electrode fixed concentrically within the pipe, a ground electrode fixed at an intermediate position within the pipe and in concentric relation around the high voltage electrode, a gas sparger, a driving circuit and power source for generating an electrical discharge between the ground electrode and high voltage electrode and creating a plasma generation region, the method comprising the steps of flowing liquid into the bubbling discharge reactor; generating the electrical discharge between the ground electrode and high voltage electrode to create the plasma generation region; causing the liquid to flow through the plasma generation region; and draining the liquid after it has flowed through the plasma generation region.

These and other aspects of the invention will be apparent from the embodiments described below.

### BRIEF DESCRIPTION OF THE DRAWINGS

The present invention will be more fully understood and appreciated by reading the following Detailed Description in conjunction with the accompanying drawings, in which:

FIG. 1A is an elevation view of an annular bubbling reactor with concurrent gas-liquid flow mode in which both gas and liquid are introduced at the bottom of the reactor and rise concurrently through the reactor, in accordance with an embodiment.

FIG. 1B is an elevation view of an annular bubbling reactor with counter current gas-liquid flow mode in which the liquid is introduced at the top of the reactor and travels downwards, while the gas is introduced at the bottom of the reactor and travels against the bulk liquid flow, in accordance with an embodiment.

FIG. 1C is an elevation view of an annular bubbling reactor with gas discharge operation mode in which the solution level coincides with the top plane of the outer electrode, in accordance with an embodiment.

FIG. 1D is an elevation view of an annular bubbling reactor in a falling film configuration in which a thin film of liquid is introduced in the annular region between the electrodes and is treated along the length of the electrode by a discharge generated in the gas phase in the annular region, in accordance with an embodiment.

### DETAILED DESCRIPTION OF EMBODIMENTS

The present disclosure describes an annular bubbling electric discharge reactor (“ABR”) for treatment of water.

Referring to the figures, ABR 10 comprises a pair of electrically conductive concentric cylinders (a ground electrode and a high voltage electrode) 12, 14 of different diameters installed within a vertically oriented, pipe section 16 (composed of a composite material having both conductive and non-conductive portions). A gas sparger 18 is installed within pipe 16 and positioned adjacent the bottom on ABR 10 and is adapted to generate bubbles or foam and control the bubble size distribution. Notably, the bubble size distribution could be adjusted by an addition of a surface-active compound. The high voltage electrode 14 is fixed concentrically within the pipe 16 and the ground electrode 12 is fixed at an intermediate position within pipe 16 and in circumferential relation to the high voltage electrode 14. An electrical discharge(s) can be generated between the electrodes 12, 14 by either a pulsed DC or an AC driving circuit 30 (powered by power source 32) creating a plasma generation region 24 in the area encompassed by the ground electrode 12 or in the gas-liquid bubble mixture. A column drain 25 is located adjacent the bottom of ABR 10 and when the liquid inlet is at the top of the ABR 10, changing the diameter of the column drain and/or the liquid outlet will control the level of liquid within the ABR 10. The column drain includes a one-way valve that is closed when ABR 10 is operational. A pump 29 provides the motive force to move liquid through ABR 10.

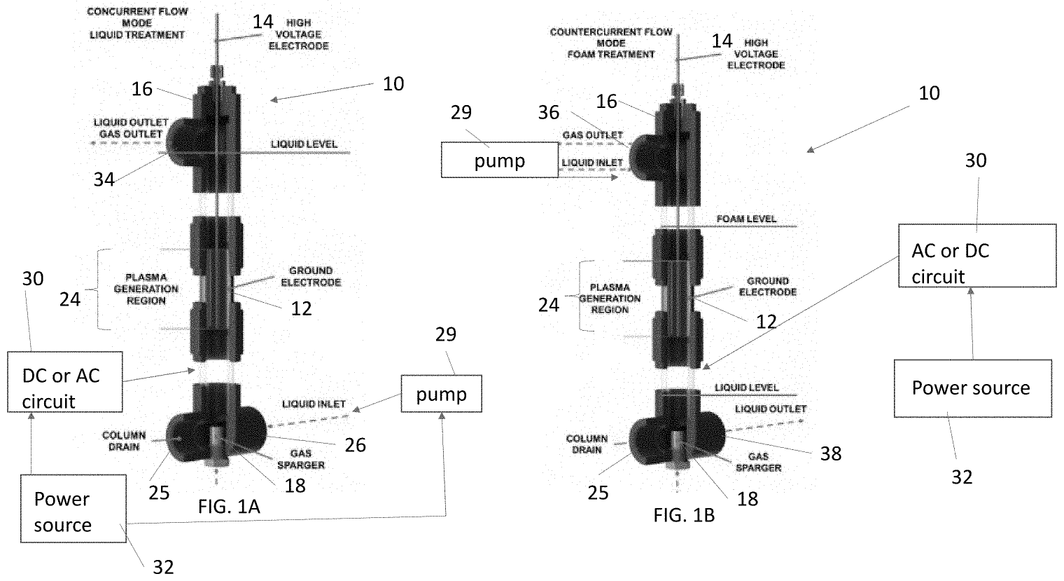

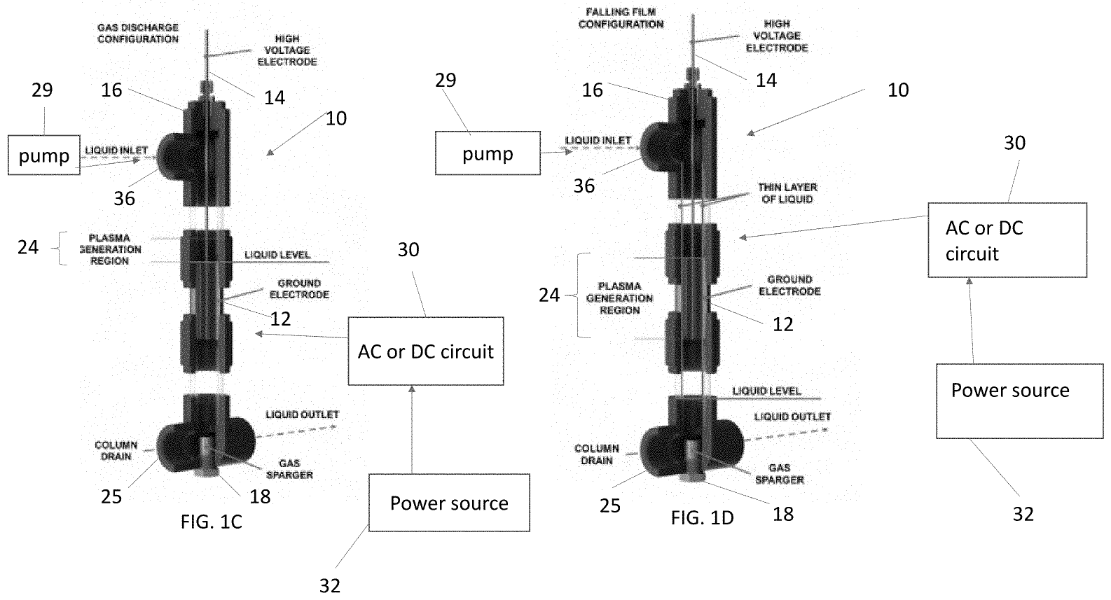

In one embodiment, shown in FIG. 1A, ABR 10 includes a liquid inlet 26 positioned at its bottom along with a column drain 28. Liquid to be treated will enter inlet 26 and rise through ABR 10 to a liquid level that is coincident with a liquid outlet 34 positioned adjacent the top of ABR 10 and is treated in plasma generation region 24 before exiting ABR 10 though liquid outlet 34. Gas is also discharged through outlet 34.

In another embodiment, shown in FIG. 1B, ABR 10 includes a liquid inlet 36 that is positioned adjacent the top of ABR 10. Liquid will travel downwards, while gas is introduced at the bottom of ABR 10 and travels against the bulk liquid flow. As the gas travels upward, the liquid level will be maintained slightly above the liquid outlet 38 which is positioned adjacent the bottom of ABR 10 and will be treated in the plasma generation region 24 with foam being produced and being at a level just above the plasma generation region 24. Gas is discharged through the liquid inlet 36.

In another embodiment, shown in FIG. 1C, ABR 10 includes a configuration that is essentially the same as that provided in FIG. 1B with the exception that the plasma generation region 24 is a smaller zone with the liquid level within ABR 10 being maintained co-planar with the top plane of ground electrode 12. With the liquid level within the reactor maintained above the top of the ground electrode, the plasma discharges are generated in the gas above the liquid and contact only the top surface of the liquid.

In another embodiment, shown in FIG. 1D, ABR 10 includes a configuration that is essentially the same as that provided in FIG. 1B and FIG. 1C, except the liquid is introduced through inlet 36 as a thin film in the annular region between electrodes 12 and 14 (the liquid adheres to the interior wall of ground electrode 12 and falls downwardly as a film that adheres to the interior wall) and is treated along the length of the electrodes by a discharge generated in the gas phase in this annular region.

While various embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings is/are used. Those skilled in the art will recognize or be able to ascertain using no more than routine experimentation, many equivalents to the specific embodiments described herein. It is, therefore, to be understood that the foregoing embodiments are presented by way of example only and that, within the scope of the appended claims and equivalents thereto, embodiments may be practiced otherwise than as specifically described and claimed. Embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present disclosure.

What is claimed is:

1. A bubbling discharge reactor for treatment of liquid, comprising:
a. a pipe having a top and a bottom;
b. a gas sparger installed within the non-conductive pipe;
c. a high voltage electrode fixed concentrically within the pipe;
d. a ground electrode fixed at an intermediate position within the and in circumferential relation to the high voltage electrode with an annular space defined between the ground electrode and high voltage electrode;
e. a liquid inlet and a liquid outlet; and
f. a circuit and power supply for generating an electrical discharge between the high voltage electrode and ground electrode, thereby creating a plasma generation region.

2. The bubbling discharge reactor of claim 1, wherein the liquid outlet is positioned adjacent the top of the reactor and the liquid inlet is positioned adjacent the bottom of the reactor.

3. The bubbling reactor of claim 1, wherein the liquid outlet is positioned adjacent the bottom of the reactor and the liquid inlet is positioned adjacent the top of the reactor.

4. The bubbling discharge reactor of claim 3, wherein the liquid inlet introduces liquid between the ground electrode and the high voltage electrode.

5. The bubbling discharge reactor of claim 1, wherein the gas sparger is positioned adjacent the bottom, and adapted to generate bubbles or foam and control the bubble size formation.

6. The bubbling discharge reactor of claim 1, wherein the pipe is composed of a composite material having both conductive and non-conductive portions.

7. A method for treating liquid in a the bubbling discharge reactor having a non-conductive pipe, a high voltage electrode fixed concentrically within the non-conductive pipe, a ground electrode fixed at an intermediate position within the non-conductive pipe and in concentric relation around the high voltage electrode, a gas sparger, a driving circuit and power source for generating an electrical discharge between the ground electrode and high voltage electrode and creating a plasma generation region, the method comprising the steps of:
a. flowing liquid into the bubbling discharge reactor;
b. generating the electrical discharge between the ground electrode and high voltage electrode to create the creating the plasma generation region;
c. causing the liquid to flow through the plasma generation region; and
d. draining the liquid after it has flowed through the plasma generation region.
